(19) United States
(12) Patent Application Publication
(10) Pub. No.: US 2025/0145041 A1
(43) Pub. Date: May 8, 2025

(54) CHARGING DEVICE AND METHOD OF CONTROLLING CHARGING DEVICE

(71) Applicant: Panasonic Automotive Systems Co., Ltd., Kanagawa (JP)

(72) Inventor: Atsushi IISAKA, Kanagawa (JP)

(21) Appl. No.: 18/903,688

(22) Filed: Oct. 1, 2024

(30) Foreign Application Priority Data
Nov. 2, 2023 (JP) 2023-188672

(51) Int. Cl. B60L 53/62; B60L 53/68; B60L 55/00

(52) U.S. Cl. CPC B60L 53/62; B60L 53/68; B60L 55/00

(57) ABSTRACT

A charging device includes a communication circuit, a battery, a terminal, a bidirectional charger, and a control circuit. The communication circuit receives interconnection information related to a technical requirement for interconnection with a system. The interconnection information is received from a charging facility that is connected to the system. The terminal allows the charging device to be connected to the charging facility. The bidirectional charger is connected between the terminal and the battery. The bidirectional charger performs bidirectional conversion between AC power and DC power. The control circuit acquires one or more parameters in accordance with the interconnection information received by the communication circuit. The control circuit controls, by using the acquired parameters, a discharging operation to the terminal performed by the bidirectional charger.

### CROSS-REFERENCE TO RELATED APPLICATIONS

This application is based upon and claims the benefit of priority from Japanese Patent Application No. 2023-188672, filed Nov. 2, 2023, the entire contents of which are incorporated herein by reference.

### FIELD

The present disclosure relates generally to a charging device and a method of controlling the charging device.

### BACKGROUND

A charging device provided with a battery can accumulate power in the battery by charging power from a charging facility to which a system is connected when connected to the charging facility (See, for example, a patent literature JP 2016-530858 A).

When such a charging device is connected to a charging facility to which a system is connected, the charging device can perform system interconnection by discharging power accumulated in the battery to the charging facility side. At that time, the charging device is desired to appropriately perform the system interconnection.

### SUMMARY

A charging device according to one aspect of the present disclosure includes a communication circuit, a battery, a terminal, a bidirectional charger, and a control circuit. The communication circuit is configured to receive interconnection information related to a technical requirement for interconnection with a system. The interconnection information is received from a charging facility connected to the system. The battery is configured to accumulate power. The terminal is configured to allow the charging device to be connected to the charging facility. The bidirectional charger is connected between the terminal and the battery. The bidirectional charger is configured to perform bidirectional conversion between AC power and DC power. The control circuit is configured to acquire one or more parameters in accordance with the interconnection information received by the communication circuit. The control circuit is configured to control, by using the acquired parameters, a discharging operation to the terminal performed by the bidirectional charger.

### BRIEF DESCRIPTION OF THE DRAWINGS

FIGS. 1A and 1B are diagrams illustrating charging and discharging at a destination of a vehicle in which a charging device according to an embodiment is mounted;

FIG. 2 is a diagram illustrating a configuration of the charging device according to the embodiment;

FIG. 3 is a diagram illustrating a configuration of a controller according to the embodiment;

FIGS. 4A and 4B are diagrams illustrating parameters for interconnection with a system in a region A in the embodiment;

FIGS. 5A and 5B are diagrams illustrating parameters for interconnection with a system in a region B in the embodiment;

FIG. 6 is a flowchart illustrating an operation of the charging device according to the embodiment;

FIG. 7 is a sequence chart showing a use case of the charging device according to the embodiment;

FIGS. 8A and 8B are diagrams illustrating charging and discharging at a destination of a vehicle in which a charging device according to a first modification of the embodiment is mounted;

FIG. 9 is a diagram illustrating a configuration of the charging device according to the first modification of the embodiment;

FIGS. 10A and 10B are diagrams illustrating charging and discharging at a destination of a vehicle in which a charging device according to a second modification of the embodiment is mounted; and

FIG. 11 is a diagram illustrating a configuration of the charging device according to the second modification of the embodiment.

### DETAILED DESCRIPTION

Hereinafter, an embodiment of a charging device according to the present disclosure will be described with reference to the drawings.

### Embodiment

The charging device according to the embodiment is provided with a battery. The charging device is capable of performing system interconnection by discharging power accumulated in the battery to a charging facility to which a system is connected, when the charging device is connected to the charging facility. According to the present embodiment, the system interconnection can be appropriately performed.

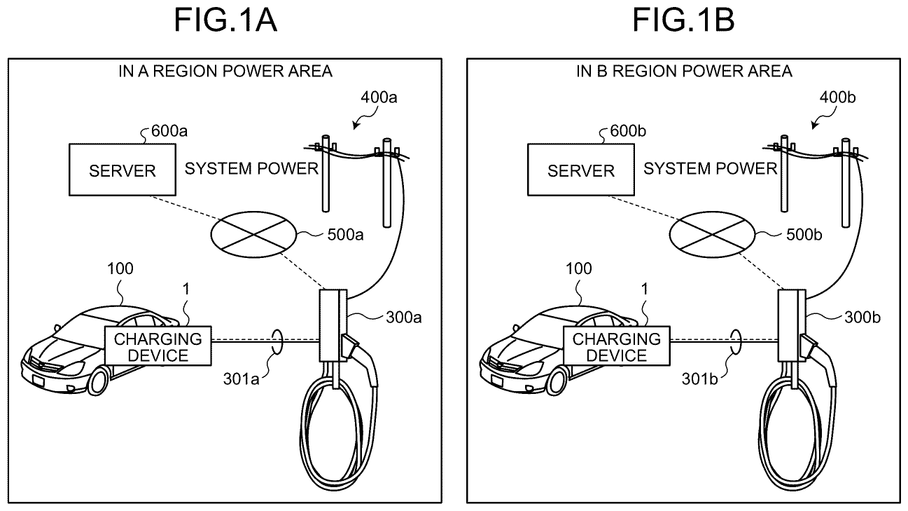

As illustrated in FIGS. 1A and 1B, a charging device 1 may be mounted on a vehicle 100. FIGS. 1A and 1B are diagrams illustrating charging and discharging at a destination of the vehicle 100 in which the charging device 1 is mounted.

The vehicle 100 is assumed to be an optional movable body that can be charged and is equipped with wheels.

The vehicle 100 may be, for example, an electric vehicle (EV) type moving body or a plug-in hybrid vehicle (PHV) type moving body. The vehicle 100 may be a two-wheeled vehicle, a three-wheeled vehicle, a four-wheeled vehicle, or a movable body with five or more wheels. Hereinafter, a case where the vehicle 100 is an EV-type four-wheeled vehicle will be mainly described.

As a charging infrastructure for the vehicle 100 on which the charging device 1 is mounted, a plurality of charging stations exist in a plurality of regions. Each charging station is equipped with a charging facility 300.

As illustrated in FIG. 1A, in a case where the destination of the vehicle 100 is a region A, the vehicle 100 is able to charge the battery of the charging device 1 by connecting the charging device 1 to a charging facility 300a at the charging station in the region A. The charging facility 300a is connected to a system 400a in the region A via a power distribution network, and is also connected to a server 600a in the region A via a communication line 500a. The communication line 500a may be a wired communication line and/or a wireless communication link. The system 400a and the server 600a in the region A are each managed by a power transmission and distribution provider in the region A.

When the charging device 1 is connected to the charging facility 300a to which the system 400a is connected, the charging device 1 is able to perform interconnection with the system 400a in the region A by discharging the power accumulated in the battery to the charging facility 300a side.

As illustrated in FIG. 1B, in a case where the destination of the vehicle 100 is a region B, the vehicle 100 is able to charge the battery of the charging device 1 by connecting the charging device 1 to a charging facility 300b at the charging station in the region B. The charging facility 300b is connected to a system 400b in the region B via a power distribution network, and is also connected to a server 600b in the region B via a communication line 500b. The communication line 500b may be a wired communication line and/or a wireless communication link. The system 400b and the server 600b in the region B are each managed by a power transmission and distribution provider in the region B.

When the charging device 1 is connected to the charging facility 300b to which the system 400b is connected, the charging device 1 is able to perform interconnection with the system 400b in the region B by discharging the power accumulated in the battery to the charging facility 300b side.

In some cases, the power transmission and distribution provider in the region A and the power transmission and distribution provider in the region B may operate the systems 400a and 400b with different technical requirements.

Specifically, in order to be interconnected with the system in each country, it is required to follow a grid code (in a case of Japan, system interconnection regulation) defined by the corresponding country. According to the grid code, it is required to be provided with a protection function against a system accident, an operation continuation function for a given period of time, a solo operation prevention function, etc., in addition to being interconnected by the same electric system as the system. Such functions differ in voltage and frequency detection threshold values, detection time limits, and the like for each of the power transmission and distribution providers in each country (in Japan, there are 10 provides). Therefore, when a vehicle moves and interconnects to systems of different power transmission and distribution providers, it is required to change the functions so as to meet the technical requirement corresponding to the provider currently used by the vehicle.

Thus, it is desirable that the charging device 1 performs system interconnection appropriately in accordance with the technical requirement corresponding to the region of the destination where the vehicle 100 including the charging device 1 arrives.

Therefore, in the present embodiment, when the charging device 1 is connected to the charging facility 300, the charging device 1 receives interconnection information related to a technical requirement of interconnection with a system 400, and updates parameters for a discharging operation to the charging facility 300, thereby enabling system interconnection in accordance with a technical requirement for each region.

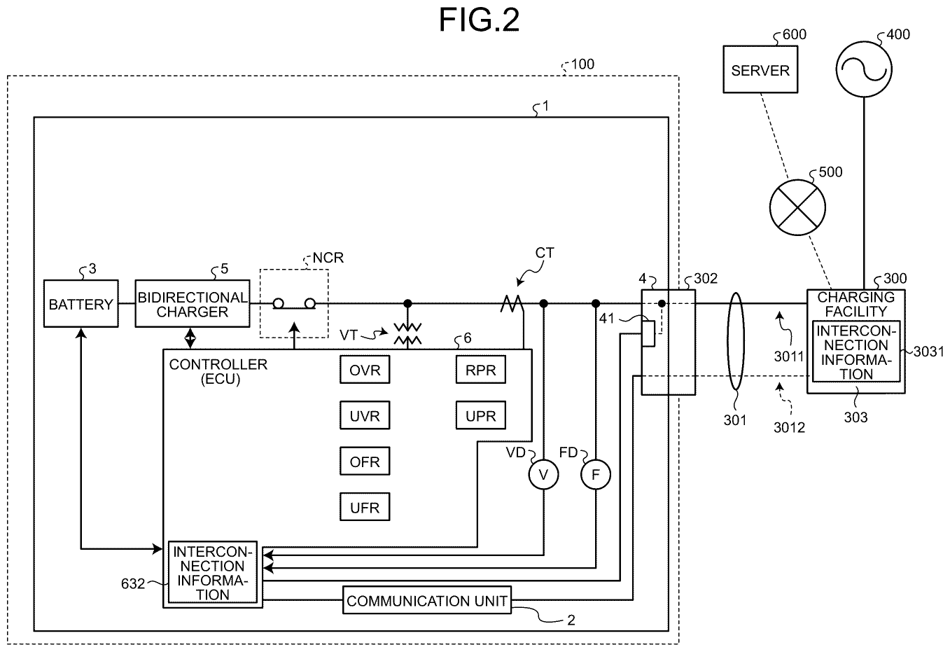

The charging device 1 can be configured as illustrated in FIG. 2. FIG. 2 is a diagram illustrating a configuration of the charging device 1.

The charging device 1 includes a communication unit 2 (an example of the communication circuit), a battery 3, a terminal 4, a bidirectional charger 5, a system interconnection relay NCR, a voltage transducer VT, a current transducer CT, a voltage detector VD, a frequency detector FD, and a controller 6 (an example of the control circuit).

The controller 6 integrally controls each unit of the charging device 1. The controller 6 may be, for example, an electronic control unit (ECU). The controller 6 may functionally include an over voltage relay OVR, an under voltage relay UVR, an over frequency relay OFR, an under frequency relay UFR, a reverse power relay RPR, and an under power relay UPR.

The terminal 4 is placed in a housing (not illustrated) of the charging device 1, and at least a part thereof is exposed to the outside. The terminal 4 allows the charging device 1 to be connected to the charging facility 300. In the charging facility 300, a main body 303 is connected to a terminal 302 via a cable 301. The terminal 4 of the charging device 1 is compliant with the terminal 302 of the charging facility 300. The terminal 4 and the terminal 302 may have structures that can be fitted to each other. In one example, the terminal 4 has a convex structure while the terminal 302 has a corresponding concave structure. When the terminal 302 of the charging facility 300 is an outlet compliant with a predetermined charging standard, the terminal 4 may be an inlet compliant with the predetermined charging standard. The cable 301 includes a power line 3011, and may further include a communication line 3012.

The charging facility 300 is connected to the system 400 in a region of a destination of the vehicle 100 via a power distribution network, and is also connected to a server 600 in a region of the destination of the vehicle 100 via a communication line 500.

The terminal 4 includes a connection detector 41. The connection detector 41 is capable of detecting connection of the terminal 302. The connection detector 41 may physically detect the connection of the terminal 302 or may electrically detect the connection of the terminal 302. Upon detecting the connection of the terminal 302, the connection detector 41 supplies a detection signal to the controller 6.

The communication unit 2 is capable of communicating with the charging facility 300. The communication unit 2 is electrically connected between the controller 6 and the terminal 4. The communication unit 2 can be connected to the charging facility 300 via the terminal 4 so as to communicate with the charging facility 300. When the terminal 4 is connected to the charging facility 300, the communication unit 2 can transmit and receive predetermined information to and from the charging facility 300 via the terminal 4.

The charging facility 300 downloads interconnection information 3031 from the server 600 via the communication line 500 in advance and stores the downloaded interconnection information 3031. The interconnection information 3031 is information about a technical requirement for interconnection with the system 400. The interconnection information 3031 may include one or more parameters corresponding to the technical requirement for interconnection with the system 400, or may include a communication address (for example, URL of the server 600) used for acquiring the parameters corresponding to the technical requirement for interconnection with the system 400.

When the terminal 4 is connected to the charging facility 300, the communication unit 2 transmits a request for interconnection information (hereinafter, an interconnection information request) to the charging facility 300 under the control of the controller 6. The communication unit 2 receives interconnection information from the charging facility 300 in response to the interconnection information request, and supplies the interconnection information to the controller 6. The controller 6 stores interconnection information 632. The controller 6 acquires parameters in accordance with the interconnection information 632. In a case where the interconnection information 632 includes parameters, the controller 6 may acquire the parameters by extracting the parameters from the interconnection information 632. In a case where the interconnection information 632 includes a communication address for acquiring parameters, the controller 6 may acquire the parameters from the server 600 by accessing the server 600 with the communication address via the communication unit 2, the terminal 4, the charging facility 300, and the communication line 500. Then, the controller 6 can control, by using the acquired parameters, the discharging operation to the terminal 4 side performed by the bidirectional charger 5.

The battery 3 is capable of accumulating power. The battery 3 may be a power accumulation component such as an electric double layer capacitor or an electrolytic capacitor, or may be a secondary battery such as a lead storage battery, a lithium ion battery, a nickel hydrogen battery, a nickel cadmium battery, or an all-solid-state battery.

The bidirectional charger 5 is connected between the terminal 4 and the battery 3. The bidirectional charger 5 is capable of performing bidirectional conversion between AC power and DC power under the control of the controller 6.

The bidirectional charger 5 can be controlled by the controller 6 to perform a charging operation when the charging facility 300 is connected to the terminal 4. The bidirectional charger 5 may receive AC power from the charging facility 300 via the terminal 4, convert the AC power into DC power, and supply the DC power to the battery 3. As a result, the battery 3 can be charged.

The bidirectional charger 5 can be controlled by the controller 6 to perform a discharging operation when the charging facility 300 is connected to the terminal 4. The bidirectional charger 5 may receive DC power from the battery 3, convert the DC power into AC power, and supply the AC power to the charging facility 300 via the terminal 4. As a result, the battery 3 can be discharged.

The system interconnection relay NCR is inserted into a line LN that connects the terminal 4 and the bidirectional charger 5. In the system interconnection relay NCR, one end is connected to the terminal 4 while the other end is connected to the bidirectional charger 5, and a control terminal is connected to the controller 6. The system interconnection relay NCR is a normally-closed relay. The system interconnection relay NCR is in an ON state in a normal state, and electrically connects the terminal 4 to the bidirectional charger 5. Thus, the charging device 1 can be interconnected with the system 400. The system interconnection relay NCR can shift to an OFF state under the control of the controller 6. The system interconnection relay NCR is kept in the OFF state under the control of the controller 6, thereby electrically disconnecting the bidirectional charger 5 from the terminal 4. As a result, the interconnection with the system 400 by the charging device 1 is stopped (or suspended). After that, when the system interconnection relay NCR is released from the OFF state and returned to the ON state under the control of the controller 6, the system interconnection relay NCR electrically connecting the terminal 4 to the bidirectional charger 5 again. As a result, the charging device 1 is restored to a state communicable with the system 400.

The voltage transducer VT is connected between the line LN and the controller 6. In the voltage transducer VT, a primary side is connected to the line LN while a secondary side is connected to the controller 6. The voltage transducer VT transmits the voltage of the line LN to the controller 6. The controller 6 supplies the voltage of the line LN to the over voltage relay OVR, the under voltage relay UVR, the over frequency relay OFR, and the under frequency relay UFR.

The over voltage relay OVR is capable of detecting a physical quantity related to the voltage of the line LN. The over voltage relay OVR serves to detect overvoltage of the line LN by receiving the voltage of the line LN via the voltage transducer VT.

In the over voltage relay OVR, parameters PT1 and PT2 according to the interconnection information 632 can be set by the controller 6, and the overvoltage of the line LN can be detected based on the set parameters PT1 and PT2. The parameter PT1 is a parameter related to voltage, and the parameter PT2 is a parameter related to time. In accordance with the interconnection information 632, the controller 6 may set, in the over voltage relay OVR, the parameter PT1 as a voltage threshold value for detecting the overvoltage, and may set, in the over voltage relay OVR, the parameter PT2 as a detection time for detecting the overvoltage. When a state where the voltage of the line LN exceeds the voltage threshold value continues for the detection time or longer, the over voltage relay OVR may detect that the overvoltage occurs on the line LN.

When the overvoltage of the line LN is detected, the over voltage relay OVR supplies a detection signal to the controller 6. In response to the detection signal from the over voltage relay OVR, the controller 6 may shift the system interconnection relay NCR to the OFF state to stop the discharging operation of the bidirectional charger 5.

The under voltage relay UVR is capable of detecting a physical quantity related to the voltage of the line LN. The under voltage relay UVR serves to detect undervoltage of the line LN by receiving the voltage of the line LN via the voltage transducer VT.

In the under voltage relay UVR, parameters PT3 and PT4 according to the interconnection information 632 can be set by the controller 6, and the undervoltage of the line LN can be detected based on the set parameters PT3 and PT4. The parameter PT3 is a parameter related to voltage, and the parameter PT4 is a parameter related to time. In accordance with the interconnection information 632, the controller 6 may set, in the under voltage relay UVR, the parameter PT3 as a voltage threshold value for detecting the undervoltage, and may set, in the under voltage relay UVR, the parameter PT4a as a detection time for detecting the undervoltage. When a state where the voltage of the line LN falls below the voltage threshold value continues for the detection time or longer, the under voltage relay UVR may detect that the undervoltage occurs on the line LN.

When the undervoltage of the line LN is detected, the under voltage relay UVR supplies a detection signal to the controller 6. In response to the detection signal from the under voltage relay UVR, the controller 6 may shift the system interconnection relay NCR to the OFF state to stop the discharging operation of the bidirectional charger 5.

The over frequency relay OFR is capable of detecting a physical quantity related to a frequency of the line LN. The over frequency relay OFR serves to detect increase in frequency of the voltage of the line LN by receiving the voltage of the line LN via the voltage transducer VT.

In the over frequency relay OFR, parameters PT5 and PT6 according to the interconnection information 632 can be set by the controller 6, and the increase in frequency of the voltage of the line LN can be detected based on the set parameters PT5 and PT6. The parameter PT5 is a parameter related to frequency, and the parameter PT6 is a parameter related to time. If the charging device 1 continues to solely operate while the system 400 is stopped, the frequency of the voltage supplied to the charging device 1 may increase more than an appropriate value. In accordance with the interconnection information 632, the controller 6 may set, in the over frequency relay OFR, the parameter PT5 as a frequency threshold value for detecting the solo operation during a stoppage of the system 400, and may set, in the over frequency relay OFR, the parameter PT6 as a detection time for detecting the solo operation. When a state where the frequency of the voltage of the line LN exceeds the frequency threshold value continues for the detection time or longer, the over frequency relay OFR may detect that the frequency of the voltage of the line LN increases.

When the increase in frequency of the voltage of the line LN is detected, the over frequency relay OFR supplies a detection signal to the controller 6. In response to the detection signal from the over frequency relay OFR, the controller 6 may shift the system interconnection relay NCR to the OFF state to stop the discharging operation of the bidirectional charger 5.

The under frequency relay UFR is capable of detecting a physical quantity related to the frequency of the line LN. The under frequency relay UFR serves to detect decrease in frequency of the voltage of the line LN by receiving the voltage of the line LN via the voltage transducer VT.

In the under frequency relay UFR, parameters PT7 and PT8 according to the interconnection information 632 can be set by the controller 6, and the decrease in frequency of the voltage of the line LN can be detected based on the set parameters PT7 and PT8. The parameter PT7 is a parameter related to frequency, and the parameter PT8 is a parameter related to time. If the charging device 1 continues to solely operate while the system 400 is stopped, the frequency of the voltage supplied to the charging device 1 may decrease from an appropriate value. In accordance with the interconnection information 632, the controller 6 may set, in the frequency reduction relay UFR, the parameter PT7 as a frequency threshold value for detecting the solo operation during a stoppage of the system 400, and may set, in the under frequency relay UFR, the parameter PT8 as a detection time for detecting the solo operation. When a state where the frequency of the voltage of the line LN falls below the frequency threshold value continues for the detection time or longer, the under frequency relay UFR may detect that the frequency of the voltage of the line LN decreases.

When the decrease in frequency of the voltage of the line LN is detected, the under frequency relay UFR supplies a detection signal to the controller 6. In response to the detection signal from the under frequency relay UFR, the controller 6 may shift the system interconnection relay NCR to the OFF state to stop the discharging operation of the bidirectional charger 5.

The current transducer CT is provided between the line LN and the controller 6. The current transducer CT is placed around the line LN. One end of the current transducer CT is connected to the controller 6. The current transducer CT transmits the current of the line LN to the controller 6. The controller 6 supplies the current of the line LN to the reverse power relay RPR and the under power relay UPR.

The reverse power relay RPR is capable of detecting a physical quantity related to the power of the line LN. The reverse power relay RPR serves to detect the reverse power of the line LN by receiving the current of the line LN via the current transducer CT.

In the reverse power relay RPR, parameters PT9 and PT10 according to the interconnection information 632 can be set by the controller 6, and the reverse power of the line LN can be detected based on the set parameters PT9 and PT10. The parameter PT9 is a parameter related to power, and the parameter PT10 is a parameter related to time. If the charging device 1 continues to solely operate while the system 400 is stopped, power supplied to the charging device 1 may be transmitted in the opposite direction. In accordance with the interconnection information 632, the controller 6 may set, in the reverse power relay RPR, the parameter PT9 as a power threshold value for detecting occurrence of the reverse power during a stoppage of the system 400, and may set, in the reverse power relay RPR, the parameter PT10 as a detection time for detecting the reverse power. When a state where the power in the reverse direction of the line LN exceeds the power threshold value continues for the detection time or longer, the reverse power relay RPR may detect that the reverse power of the line LN occurs.

When the reverse power of the line LN is detected, the reverse power relay RPR supplies a detection signal to the controller 6. In response to the detection signal from the reverse power relay RPR, the controller 6 may shift the system interconnection relay NCR to the OFF state to stop the discharging operation of the bidirectional charger 5.

The under power relay UPR is capable of detecting a physical quantity related to the power of the line LN. The under power relay UPR serves to detect the underpower of the line LN by receiving the current of the line LN via the current transducer CT.

In the under power relay UPR, parameters PT11 and PT12 according to the interconnection information 632 can be set by the controller 6, and the underpower of the line LN can be detected based on the set parameters PT11 and PT12. The parameter PT11 is a parameter related to power, and the parameter PT12 is a parameter related to time. In accordance with the interconnection information 632, the controller 6 may set, in the under power relay UPR, the parameter PT11 as a power threshold value detecting the underpower, and may set, in the under power relay UPR, the parameter PT12 as a detection time for detecting occurrence of the underpower. When a state where the power of the line LN is lower than the power threshold value continues for the detection time or longer, the under power relay UPR may detect that the underpower occurs on the line LN.

When the underpower of the line LN is detected, the under power relay UPR supplies a detection signal to the controller 6. In response to the detection signal from the under power relay UPR, the controller 6 may shift the system interconnection relay NCR to the OFF state to stop the discharging operation of the bidirectional charger 5.

In the voltage detector VD, one end is connected to the line LN and the other end is connected to the controller 6. The voltage detector VD is configured to detect amplitude of voltage of the line LN and supply the controller 6 with the detected amplitude of the voltage.

The controller 6 acquires parameters PT13 and PT14 according to the interconnection information 632. The parameter PT13 is a parameter related to voltage, and the parameter PT14 is a parameter related to time. Even when voltage of the system 400 temporarily drops, the operation of the charging device 1 can be continued unless the system 400 is stopped. The controller 6 may acquire the parameter PT13 as an allowable voltage range of the voltage drop of the system 400 and acquire the parameter PT14 as an allowable time of the voltage drop of the system 400. The controller 6 may control the discharging operation of the bidirectional charger 5 to be continued by keeping the ON state of the system interconnection relay NCR in accordance with the amplitude of the voltage detected by the voltage detector VD, the parameter PT13, and the parameter PT14. The controller 6 may control the discharging operation of the bidirectional charger 5 to be continued by keeping the ON state of the system interconnection relay NCR until the duration of a state where the amplitude of the voltage detected by the voltage detector VD falls outside the allowable voltage range reaches the allowable time.

In the frequency detector FD, one end is connected to the line LN and the other end is connected to the controller 6. The frequency detector FD is configured to detect frequency of the voltage of the line LN and supply the controller 6 with the detected frequency of the voltage.

The controller 6 acquires parameters PT15 and PT16 according to the interconnection information 632. The parameter PT15 is a parameter related to frequency, and the parameter PT16 is a parameter related to time. Even when the frequency of the system 400 temporarily fluctuates, the operation of the charging device 1 can be continued unless the system 400 is stopped. The controller 6 may acquire the parameter PT15 as an allowable frequency range of the frequency fluctuation of the system 400, and may acquire the parameter PT16 as an allowable time of the frequency fluctuation of the system 400. The controller 6 may control the discharging operation of the bidirectional charger 5 to be continued by keeping the ON state of the system interconnection relay NCR in accordance with the frequency of the voltage detected by the frequency detector FD, the parameter PT15, and the parameter PT16. The controller 6 may control the discharging operation of the bidirectional charger 5 to be continued by keeping the ON state of the system interconnection relay NCR until the duration of a state where the frequency of the voltage detected by the frequency detector FD falls outside the allowable frequency range reaches the allowable time.

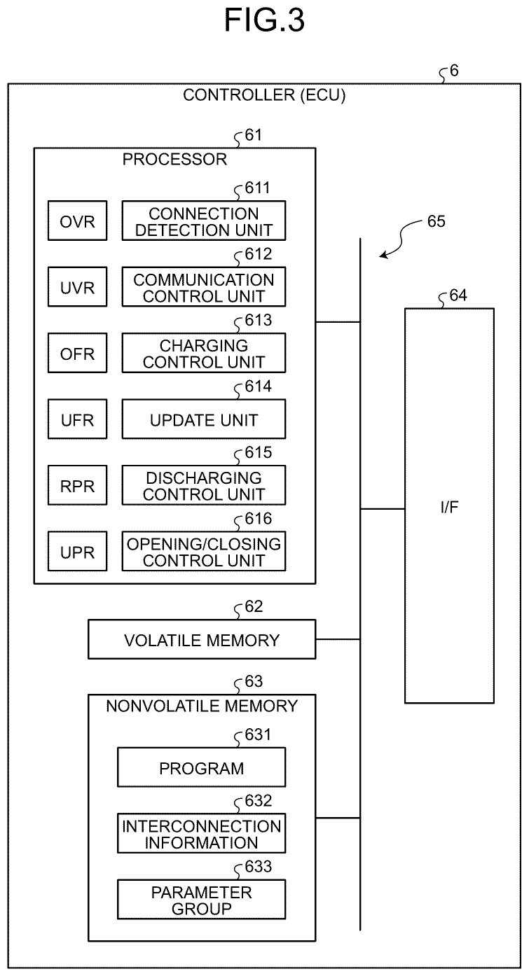

Next, a configuration of the controller 6 will be described with reference to FIG. 3. FIG. 3 is a diagram illustrating a configuration of the controller 6.

The controller 6 includes a processor 61, a volatile memory 62, a nonvolatile memory 63, an interface (I/F) 64, and a bus 65. The processor 61, the volatile memory 62, the nonvolatile memory 63, and the interface (I/F) 64 are communicably connected to each other via the bus 65.

The interface 64 is connected to the communication unit 2, the battery 3, the terminal 4, the bidirectional charger 5, the system interconnection relay NCR, the voltage transducer VT, the current transducer CT, the voltage detector VD, and the frequency detector FD.

As the volatile memory 62, a memory that is capable of temporarily storing information can be used, such as, for example, a dynamic random access memory (DRAM).

As the nonvolatile memory 63, a memory that is capable of storing information in a nonvolatile manner can be used, such as, for example, a flash memory. The nonvolatile memory 63 stores a computer program 631, the interconnection information 632, and a parameter group 633 in a nonvolatile manner. The computer program 631 may be firmware for controlling each unit of the charging device 1. The interconnection information 632 is information about technical requirements for interconnection with the system 400. The interconnection information 632 may include a parameter group corresponding to the technical requirement for interconnection with the system 400, or may include a communication address (for example, URL of the server 600) for acquiring the parameter group corresponding to the technical requirement for interconnection with the system 400. The parameter group 633 includes parameters respectively corresponding to the technical requirement of interconnection with the system 400. The parameter group 633 may include the above-described parameters PT1 to PT16.

The processor 61 functionally includes a connection detection unit 611, a communication control unit 612, a charging control unit 613, an update unit 614, a discharging control unit 615, an opening/closing control unit 616, the over voltage relay OVR, the under voltage relay UVR, the over frequency relay OFR, the under frequency relay UFR, the reverse power relay RPR, and the under power relay UPR. All the units in the processor 61 may be implemented by hardware (for example, as a circuit or circuitry) in the controller 6, or all the units may be implemented by software in the controller 6. Alternatively, part of the units in the processor 61 may be implemented by hardware, and the remaining part of the units may be implemented by software. The functions implemented by software may be developed as functional modules in the volatile memory 62 collectively during compilation or sequentially along the progress of processing by the processor 61 executing the computer program 631. As a result, each unit can be equivalently regarded as being implemented by software in the processor 61.

The connection detection unit 611 serves to detect connection of the charging facility 300 to the terminal 4 via the connection detector 41. When the connection of the terminal 302 is detected, the connection detector 41 supplies a detection signal to the connection detection unit 611. The connection detection unit 611 detects, by the detection signal, connection between the charging facility 300 and the terminal 4. The connection detection unit 611 can transmit notification of detection of connection between the charging facility 300 to the terminal 4, to the communication control unit 612, the charging control unit 613, and the discharging control unit 615.

The communication control unit 612 is configured to control the communication unit 2 in response to the detection of connection between the charging facility 300 and the terminal 4. The communication control unit 612 receives a notification of connection detection between the charging facility 300 and the terminal 4 from the connection detection unit 611. In response to the notification of connection detection, the communication control unit 612 generates an interconnection information request and supplies it to the communication unit 2. The communication unit 2 transmits the interconnection information request from the communication unit 2 to the charging facility 300. When the communication unit 2 receives interconnection information from the charging facility 300 in response to the interconnection information request, the communication control unit 612 is given the interconnection information from the communication unit 2 and stores the interconnection information in the nonvolatile memory 63 as the interconnection information 632.

The charging control unit 613 is configured to control the battery 3 and the bidirectional charger 5 in response to the detection of connection between the charging facility 300 and the terminal 4. The charging control unit 613 receives a notification of the connection detection between the charging facility 300 and the terminal 4 from the connection detection unit 611. Upon receiving the notification of connection detection, the charging control unit 613 controls the bidirectional charger 5 to perform the charging operation. The charging control unit 613 controls the battery 3 and the bidirectional charger 5 so that AC power received from the charging facility 300 via the terminal 4 can be converted into DC power by the bidirectional charger 5 and be supplied to the battery 3. As a result, the battery 3 can be charged.

The update unit 614 is configured to acquire a parameter group for interconnection with the system 400 in accordance with the interconnection information 632. When the interconnection information 632 includes the parameter group, the update unit 614 may acquire parameters by extracting the parameter group from the interconnection information 632. When the interconnection information 632 includes a communication address for acquiring the parameters, the update unit 614 may access the server 600 via the communication unit 2, the terminal 4, the charging facility 300, and the communication line 500 to acquire the parameter group from the server 600. The update unit 614 updates the parameter group for interconnection with the system 400 with the acquired parameter group. The update unit 614 may access the nonvolatile memory 63 and update the parameter group 633 by overwriting the parameter group 633 with the acquired parameter group.

The parameter group 633 includes parameters related to a protection function against the system accident in the system 400 of a destination of the vehicle 100, an operation continuation function for a given period of time, a solo operation prevention function, and the like.

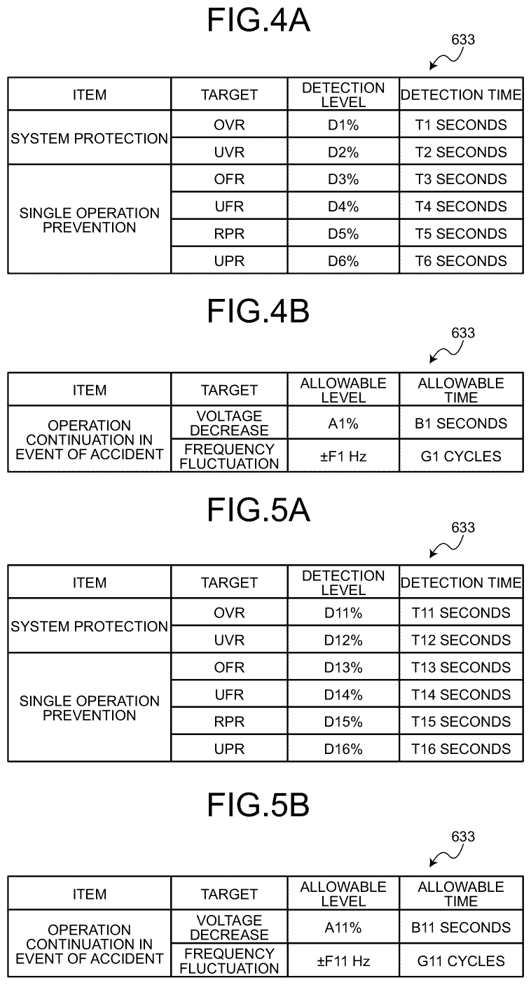

In a case where the destination of the vehicle 100 is the region A (refer to FIG. 1A), the parameter group 633 may include parameters as illustrated in FIGS. 4A and 4B. FIGS. 4A and 4B are diagrams illustrating parameters for interconnection with the system 400a in the region A. FIG. 4A illustrates parameters of a detection level and a detection time relating to the protection function in the event of the system accident and the solo operation prevention function. FIG. 4B illustrates parameters of an allowable level and an allowable time relating to the operation continuation function for a given period of time.

Regarding the protection function in the event of the system accident, as illustrated in FIG. 4A, the parameter group 633 includes the parameter PT1 for setting the detection level of the over voltage relay OVR to D1% and the parameter PT2 for setting the detection time to T1 seconds. The parameter group 633 includes the parameter PT3 for setting the detection level of the under voltage relay UVR to D2% and the parameter PT4 for setting the detection time to T2 seconds.

Regarding the solo operation prevention function, as shown in FIG. 4A, the parameter group 633 includes the parameter PT5 for setting the detection level of the over frequency relay OFR to D3% and the parameter PT6 for setting the detection time to T3 seconds. The parameter group 633 includes the parameter PT7 for setting the detection level of the under frequency relay UFR to D4% and the parameter PT8 for setting the detection time to T4 seconds. The parameter group 633 includes the parameter PT9 for setting the detection level of the reverse power relay RPR to D5% and the parameter PT10 for setting the detection time to T5 seconds. The parameter group 633 includes the parameter PT11 for setting the detection level of the under power relay UPR to D6% and the parameter PT12 for setting the detection time to T6 seconds.

Regarding the operation continuation function for a given period of time, as illustrated in FIG. 4B, the parameter group 633 includes the parameter PT13 for setting the allowable level of the voltage decrease of the system 400a to A1% or more of the rating and the parameter PT14 for setting the allowable time to B1 seconds. The parameter group 633 includes the parameter PT15 for setting the allowable level of the frequency fluctuation of the system 400a to −F1 Hz to +F1 Hz and the parameter PT16 for setting the allowable time to G1 cycles.

Alternatively, in a case where the destination of the vehicle 100 is the region B (refer to FIG. 1B), the parameter group 633 may include parameters as illustrated in FIGS. 5A and 5B. FIGS. 5A and 5B are diagrams illustrating parameters for interconnection with the system 400b in the region B. FIG. 5A illustrates parameters of a detection level and a detection time relating to the protection function in the event of the system accident and the solo operation prevention function. FIG. 5B illustrates parameters of an allowable level and an allowable time relating to the operation continuation function for a given period of time.

Regarding the protection function in the event of the system accident, as illustrated in FIG. 5A, the parameter group 633 includes the parameter PT1 for setting the detection level of the over voltage relay OVR to D11% and the parameter PT2 for setting the detection time to T11 seconds. The parameter group 633 includes the parameter PT3 for setting the detection level of the under voltage relay UVR to D12% and the parameter PT4 for setting the detection time to T12 seconds.

Regarding the solo operation prevention function, as shown in FIG. 5A, the parameter group 633 includes the parameter PT5 for setting the detection level of the over frequency relay OFR to D13% and the parameter PT6 for setting the detection time to T13 seconds. The parameter group 633 includes the parameter PT7 for setting the detection level of the under frequency relay UFR to D14% and the parameter PT8 for setting the detection time to T14 seconds. The parameter group 633 includes the parameter PT9 for setting the detection level of the reverse power relay RPR to D15% and the parameter PT10 for setting the detection time to T15 seconds. The parameter group 633 includes the parameter PT11 for setting the detection level of the under power relay UPR to D16% and the parameter PT12 for setting the detection time to T16 seconds.

Regarding the operation continuation function for a given period of time, as illustrated in FIG. 5B, the parameter group 633 includes the parameter PT13 for setting the allowable level of the voltage decrease of the system 400b to A11% or more of the rating and the parameter PT14 for setting the allowable time to B11 seconds. The parameter group 633 includes the parameter PT15 for setting the allowable level of the frequency fluctuation of the system 400b to −F11 Hz to +F11 Hz and the parameter PT16 for setting the allowable time to G11 cycles.

The update unit 614 illustrated in FIG. 3 may update the parameters PT1 and PT2 by overwriting the parameters PT1 and PT2 having been set in the over voltage relay OVR with the parameters PT1 and PT2 included in the acquired parameter group. For example, when the vehicle 100 moves from the region A to the region B, the update unit 614 may update the parameter PT1 in the over voltage relay OVR by overwriting D1% as a value of the parameter PT1 for the region A (FIG. 4A) with D11% for the region B (FIG. 5A). Similarly, the update unit 614 may update the parameter PT2 in the over voltage relay OVR by overwriting T1 seconds as a value of the parameter PT2 with T11 seconds.

The update unit 614 may update the parameters PT3 and PT4 by overwriting the parameters PT3 and PT4 having been set in the under voltage relay UVR with the parameters PT3 and PT4 included in the acquired parameter group. For example, when the vehicle 100 moves from the region A to the region B, the update unit 614 may update the parameter PT3 in the under voltage relay UVR by overwriting D2% as a value of the parameter PT3 for the region A with D12% for the region B. Similarly, the update unit 614 may update the parameter PT4 in the under voltage relay UVR by overwriting T2 seconds as a value of the parameter PT4 for the region A with T12 seconds for the region B.

The update unit 614 may update the parameters PT5 and PT6 by overwriting the parameters PT5 and PT6 having been set in the over frequency relay OFR with the parameters PT5 and PT6 included in the acquired parameter group. For example, when the vehicle 100 moves from the region A to the region B, the update unit 614 may update the parameter PT5 in the over frequency relay OFR by overwriting D3% as a value of the parameter PT5 for the region A with D13% for the region B. Similarly, the update unit 614 may update the parameter PT6 in the over frequency relay OFR by overwriting T4 seconds as a value of the parameter PT6 for the region A with T14 seconds for the region B.

The update unit 614 may update the parameters PT7 and PT8 by overwriting the parameters PT7 and PT8 having been set in the under frequency relay UFR with the parameters PT7 and PT8 included in the acquired parameter group. For example, when the vehicle 100 moves from the region A to the region B, the update unit 614 may update the parameter PT7 in the under frequency relay UFR by overwriting D4% as a value of the parameter PT7 for the region A with D14% for the region B. Similarly, the update unit 614 may update the parameter PT8 in the under frequency relay UFR by overwriting T4 seconds as a value of the parameter PT8 for the region A with T14 seconds for the region B.

The update unit 614 may update the parameters PT9 and PT10 by overwriting the parameters PT9 and PT10 having been set in the reverse power relay RPR with the parameters PT9 and PT10 included in the acquired parameter group. For example, when the vehicle 100 moves from the region A to the region B, the update unit 614 may update the parameter PT9 in the reverse power relay RPR by overwriting D5% as a value of the parameter PT9 for the region A with D15% for the region B. Similarly, the update unit 614 may update the parameter PT10 in the reverse power relay RPR by overwriting T5 seconds as a value of the parameter PT10 for the region A with T15 seconds for the region B.

The update unit 614 may update the parameters PT11 and PT12 by overwriting the parameters PT11 and PT12 having been set in the under power relay UPR with the parameters PT11 and PT12 included in the acquired parameter group. For example, when the vehicle 100 moves from the region A to the region B, the update unit 614 may update the parameter PT11 in the under power relay UPR by overwriting D6% as a value of the parameter PT11 for the region A with D16% for the region B. Similarly, the update unit 614 may update the parameter PT12 in the under power relay UPR by overwriting T6 seconds as a value of the parameter PT12 for the region A with T16 for the region B.

The discharging control unit 615 is configured to control the battery 3 and the bidirectional charger 5 in response to detection of connection between the charging facility 300 and the terminal 4. The discharging control unit 615 receives a notification of the connection detection between the charging facility 300 and the terminal 4 from the connection detection unit 611. Upon receiving the notification of connection detection, the discharging control unit 615 controls the bidirectional charger 5 to perform the discharging operation. The discharging control unit 615 controls the battery 3 and the bidirectional charger 5 so that DC power received from the battery 3 can be converted into AC power by the bidirectional charger 5 and be supplied to the charging facility 300 via the terminal 4. As a result, the battery 3 can be discharged.

The opening/closing control unit 616 is configured to control opening and closing of the system interconnection relay NCR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the over voltage relay OVR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the under voltage relay UVR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the over frequency relay OFR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the under frequency relay UFR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the reverse power relay RPR.

In the period during which the discharging operation is controlled by the discharging control unit 615, the opening/closing control unit 616 may stop the discharging operation of the bidirectional charger 5 by shifting the system interconnection relay NCR to the OFF state in response to the detection signal from the under power relay UPR.

In the period during which the discharging operation is controlled by the discharging control unit 615, the opening/closing control unit 616 may continue the discharging operation of the bidirectional charger 5 by keeping the ON state of the system interconnection relay NCR in accordance with the amplitude of the voltage detected by the voltage detector VD, the parameter PT13, and the parameter PT14. The opening/closing control unit 616 may continue the discharging operation of the bidirectional charger 5 by keeping the ON state of the system interconnection relay NCR, until the duration of a state where the amplitude of the voltage detected by the voltage detector VD falls outside the allowable voltage range reaches the allowable time.

In the period during which the discharging operation is controlled by the discharging control unit 615, the opening/closing control unit 616 may continue the discharging operation of the bidirectional charger 5 by keeping the ON state of the system interconnection relay NCR in accordance with the frequency of the voltage detected by the frequency detector FD, the parameter PT15, and the parameter PT16. The opening/closing control unit 616 may continue the discharging operation of the bidirectional charger 5 by keeping the ON state of the system interconnection relay NCR, until the duration of a state where the frequency of the voltage detected by the frequency detector FD falls outside the allowable frequency range reaches the allowable time.

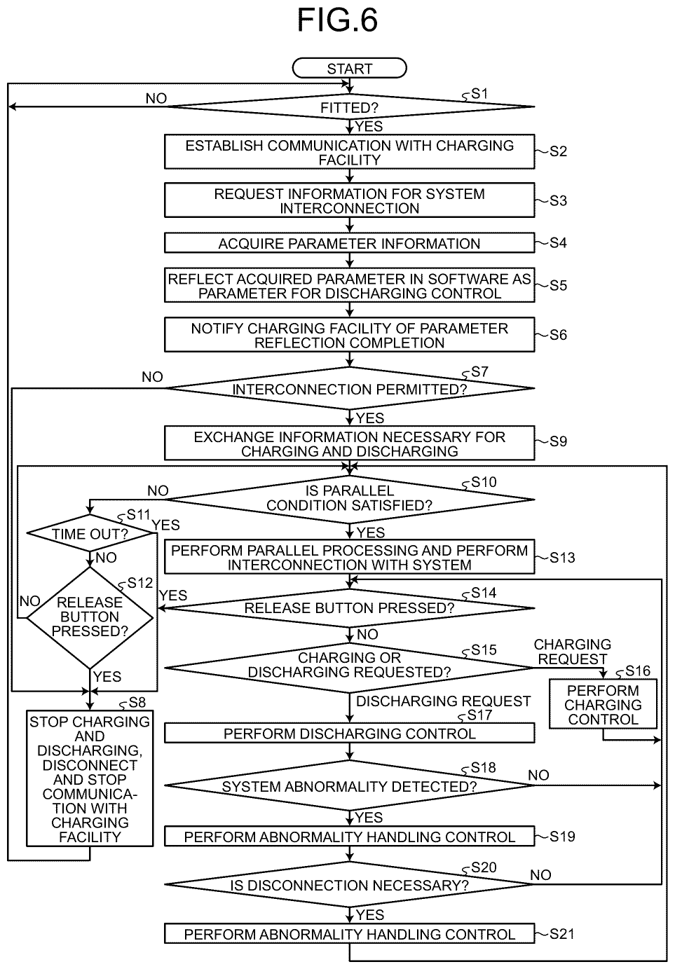

Next, the operation of the charging device 1 will be described with reference to FIG. 6. FIG. 6 is a flowchart illustrating the operation of the charging device 1. FIG. 6 illustrates a case in which each unit in the processor 61 is implemented by software.

In the charging device 1, the controller 6 waits until detecting that the terminal 302 of the charging facility 300 is fitted to the terminal 4 (No in S1).

When the controller 6 detects that the terminal 302 of the charging facility 300 is fitted to the terminal 4 (Yes in S1), the controller 6 controls the communication unit 2 to establish communication with the charging facility 300 (S2) and transmit an interconnection information request for requesting information for system interconnection to the charging facility 300 (S3).

When the communication unit 2 receives interconnection information from the charging facility 300 in response to the interconnection information request, the controller 6 stores the received interconnection information as the interconnection information 632. The controller 6 acquires parameters based on the interconnection information 632 (S4), and reflects the acquired parameters to software as parameters for discharging control (S5). In one example, the controller 6 updates the parameter group 633 to be used by the computer program 631 by overwriting the parameter group 633 of the nonvolatile memory 63 with the acquired parameter group. The controller 6 transmits, to the charging facility 300, a notification of completion of reflecting the parameters (S6). In one example, the notification includes version of interconnection destination and system interconnection technical requirement simultaneously reflected.

The controller 6 determines whether interconnection with the system 400 is permitted (S7). In one example, when the controller 6 cannot receive an interconnection permission notification from the charging facility 300 within a predetermined time after the notification in S6 is made, the controller 6 determines that the interconnection is not permitted (No in S7). In this case, the controller 6 stops charging and discharging by the bidirectional charger 5, turns off (opens) the system interconnection relay NCR to perform disconnection, and stops communication with the charging facility 300 by the communication unit 2 (S8). With this procedure, the controller 6 releases the interconnection with the system 400.

When the controller 6 receives the interconnection permission notification from the charging facility 300 within the predetermined time after the notification in S6 is made, the controller 6 determines that the interconnection is permitted (Yes in S7). In this case, the controller 6 exchanges information necessary for charging and discharging with the charging facility 300 via the communication unit 2 (S9). The information supplied from the charging device 1 to the charging facility 300 includes a charging/discharging current upper limit value, battery information, a departure time, a target SOC, and the like. The information supplied from the charging facility 300 to the charging device 1 includes a charging/discharging allowable current value and the like.

The controller 6 determines whether a parallel condition compliant to the system interconnection technical requirements is satisfied (S10). The parallel condition compliant to the system interconnection technical requirements may be, for example, conditions that enable execution of the system interconnection specified by the parameters PT1 to PT16 such as illustrated in FIGS. 4A and 5A.

In response to determining that the parallel condition compliant to the system interconnection technical requirements is not satisfied (No in S10), the controller 6 returns the processing to S10 if it is not time out from the execution of S9 (No in S11) and a fitting release button is not pressed (No in S12).

When it is time out from the execution of S9 (Yes in S11) or when the fitting release button is pressed (Yes in S12) without time out from the execution of S9 (No in S11), the controller 6 executes control such that the bidirectional charger 5 stops charging and discharging, the system interconnection relay NCR is turned off (opened) to perform disconnection, and the communication unit 2 stops communication with the charging facility 300 (S8).

In response to determining that the parallel condition compliant to the system interconnection technical requirements is satisfied (Yes in S10), the controller 6 turns on (closes) the system interconnection relay NCR to perform parallel processing (S13). As a result, the controller 6 restores the interconnection with the system 400.

Upon detecting that the fitting release button is pressed (Yes in S14), the controller 6 determines that the terminal 302 of the charging facility 300 is pulled out from the terminal 4, stops charging and discharging by the bidirectional charger 5, turns off (opens) the system interconnection relay NCR to perform disconnection, and stops communication with the charging facility 300 by the communication unit 2 (S8). As a result, the controller 6 releases the interconnection with the system 400.

When the controller 6 does not detect that the fitting release button is pressed (No in S14), the controller 6 determines whether charging or discharging is requested (S15). When charging is requested (charging request in S15), the controller 6 performs charging control within the charging allowable current value (S16).

When discharge is requested (discharging request in S15), the controller 6 performs discharging control within the discharging allowable current value (S17). When an abnormality in the system 400 is not detected (No in S18), the controller 6 returns the processing to S14.

Upon detecting an abnormality in the system 400 (Yes in S18), the controller 6 performs abnormality handling control related to the operation continuation function for a given period of time in accordance with the system interconnection technical requirement (S19).

In one example, the controller 6 may continue the discharging operation of the bidirectional charger 5 by keeping the ON state of the system interconnection relay NCR until the duration of a state where the amplitude of the voltage detected by the voltage detector VD falls outside the allowable voltage range reaches the allowable time.

Alternatively, the controller 6 may continue the discharging operation of the bidirectional charger 5 by keeping the ON state of the system interconnection relay NCR until the duration of a state where the frequency of the voltage detected by the frequency detector FD falls outside the allowable frequency range reaches the allowable time.

The controller 6 checks abnormalities related to the protection function in the event of the system accident and the solo operation prevention function, and determines whether disconnection is necessary (S20).

In one example, when no detection signal is received from any of the over voltage relay OVR, the under voltage relay UVR, the over frequency relay OFR, the under frequency relay UFR, the reverse power relay RPR, and the under power relay UPR, the controller 6 determines that disconnection is not necessary (No in S20) and returns the processing to S14.

If the detection signal is received from at least one of the over voltage relay OVR, the under voltage relay UVR, the over frequency relay OFR, the under frequency relay UFR, the reverse power relay RPR, and the under power relay UPR, the controller 6 determines that disconnection is necessary (Yes in S20). In this case, the controller 6 performs abnormality response control regarding the protection function in the event of the system accident and the solo operation prevention function in accordance with the system interconnection technical requirement (S21). Specifically, for example, the controller 6 shifts the system interconnection relay NCR to the OFF state. Thereafter, the controller 6 returns the processing to S14.

Afterwards, upon detecting that the fitting release button is pressed (Yes in S14), the controller 6 determines that the terminal 302 of the charging facility 300 is pulled out from the terminal 4. In this case, the controller 6 stops charging and discharging performed by the bidirectional charger 5, and stops communication with the charging facility 300 performed by the communication unit 2 (S8). As a result, the controller 6 releases the interconnection with the system 400.

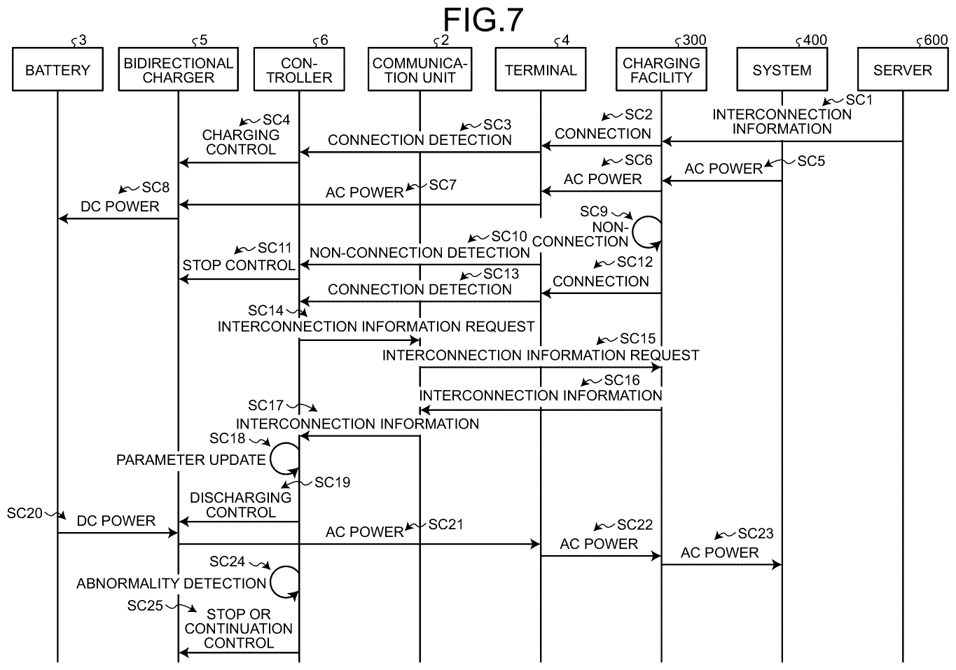

Next, a use case of the charging device 1 will be described with reference to FIG. 7. FIG. 7 is a sequence chart illustrating a use case of the charging device.

The charging facility 300 receives interconnection information 3031 from the server 600 (SC1) and stores the interconnection information 3031.

When the terminal 4 of the charging device 1 is connected to the terminal 302 of the charging facility 300 (SC2), the connection detector 41 supplies the controller 6 with an active level detection signal indicating detection of connection (SC3).

Upon receiving the detection signal of the connection detection, the controller 6 controls charging of the bidirectional charger 5 when a predetermined condition is satisfied (for example, when the remaining amount of the battery 3 is equal to or less than a lower side reference value) (SC4). In response thereto, AC power is transmitted from the system 400 to the charging facility 300 (SC5), the AC power is transmitted from the charging facility 300 to the terminal 4 (SC6), the AC power is transmitted from the terminal 4 to the bidirectional charger 5 (SC7), the AC power is converted into DC power by the bidirectional charger 5, and the DC power is supplied from the bidirectional charger 5 to the battery 3 (SC8).

When the terminal 4 of the charging device 1 is pulled out from the terminal 302 of the charging facility 300 and the charging device 1 enters a non-connection state (SC9), the connection detector 41 supplies the controller 6 with a non-active level detection signal indicating detection of the non-connection state (SC10).

When the detection signal of the non-connection state is received, the controller 6 controls the bidirectional charger 5 to stop (SC11).

When the charging facility 300 is connected to the terminal 4 again (SC12), the connection detector 41 supplies the controller 6 with the active level detection signal indicating detection of connection (SC13).

Upon receiving the detection signal of the connection detection, the controller 6 generates an interconnection information request and supplies the request to the communication unit 2 when a predetermined condition is satisfied (for example, when the remaining amount of the battery 3 is equal to or larger than an upper side reference value) (SC14). The communication unit 2 transmits the interconnection information request to the charging facility 300 (SC15).

Upon receiving the interconnection information request, the charging facility 300 transmits the interconnection information 3031 to the communication unit 2 in accordance with the interconnection information request (SC16).

Upon receiving the interconnection information, the communication unit 2 supplies the interconnection information to the controller 6 (SC17). The controller 6 stores the received interconnection information as the interconnection information 632. The controller 6 acquires parameters in accordance with the interconnection information 632 and updates parameters for interconnection with the system 400 by using the acquired parameters (SC18).

The controller 6 performs discharging control on the bidirectional charger 5 (SC19). In response thereto, DC power is transmitted from the battery 3 to the bidirectional charger 5 (SC20), the DC power is converted into AC power by the bidirectional charger 5, the AC power is transmitted from the bidirectional charger 5 to the terminal 4 (SC21), the AC power is transmitted from the terminal 4 to the charging facility 300 (SC22), and the AC power is transmitted from the charging facility 300 to the system 400 (SC23).

When the abnormality of the system 400 is detected (SC24), the controller 6 stops or continues the discharging operation of the bidirectional charger 5 in accordance with the updated parameters (SC25).

Specifically, for example, when the controller 6 receives a detection signal from at least one of the over voltage relay OVR, the under voltage relay UVR, the over frequency relay OFR, the under frequency relay UFR, the reverse power relay RPR, and the under power relay UPR, the controller 6 stops the discharging operation of the bidirectional charger 5 by shifting the system interconnection relay NCR to the OFF state.

Alternatively, the controller 6 continues the discharging operation of the bidirectional charger 5 by keeping the ON state of the system interconnection relay NCR until the duration of a state where the amplitude of the voltage detected by the voltage detector VD falls outside the allowable voltage range reaches the allowable time.

Alternatively, the controller 6 continues the discharging operation of the bidirectional charger 5 by keeping the ON state of the system interconnection relay NCR until the duration of a state where the frequency of the voltage detected by the frequency detector FD falls outside the allowable frequency range reaches the allowable time.

As described above, in the present embodiment, when the charging device 1 is connected to the charging facility 300, the charging device 1 receives the interconnection information related to the technical requirement of interconnection with the system 400, and updates the parameters used for the discharging operation to the charging facility 300. Therefore, the charging device 1 can perform system interconnection in accordance with the technical requirement for each region.

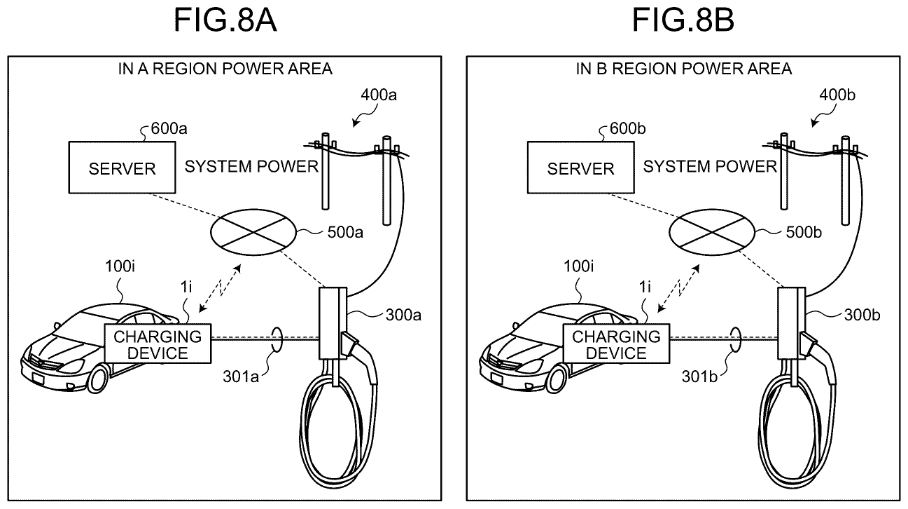

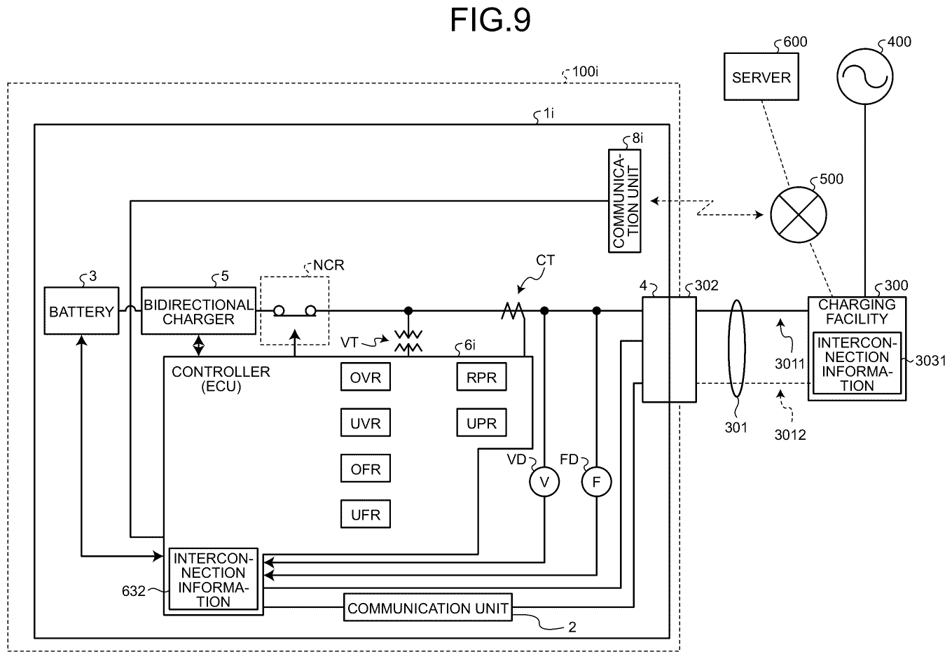

Note that, as illustrated in FIGS. 8A and 8B, and FIG. 9, a charging device li of a vehicle 100i may be capable of performing wired communication and wireless communication, as a first modification of the embodiment. FIGS. 8A and 8B are diagrams illustrating charging and discharging at a destination of the vehicle 100i in which the charging device li according to the first modification of the embodiment is mounted. FIG. 9 is a diagram illustrating a configuration of the charging device li according to the first modification of the embodiment.

As illustrated in FIG. 9, the charging device li includes a communication unit 8i in addition to the configuration of the charging device 1 in the above-described embodiment (FIG. 1). The communication unit 2 serves to communicate with the charging facility 300 via the communication line 3012 in the cable 301, whereas the communication unit 8i serves to communicate with the server 600 by a wireless communication link and the communication line 500. The communication unit 8i is connected to a controller 6i.

In one example, as illustrated in FIG. 8A, in a case where the destination of the vehicle 100i is the region A, the charging device li receives interconnection information from the charging facility 300a via a cable 301a when the charging device li is connected to the charging facility 300a at the charging station in the region A. Then, the charging device 1i stores the interconnection information as the interconnection information 632. When the interconnection information 632 includes a communication address for acquiring parameters, the controller 6i may access the server 600a through the communication unit 8i and the communication line 500a to acquire the parameters from the server 600a. As a result, the controller 6i can control the discharging operation of the bidirectional charger 5 to the terminal 4 side using the parameters corresponding to the region A.

Alternatively, as illustrated in FIG. 8B, in a case where the destination of the vehicle 100i is the region B, the charging device li receives interconnection information from the charging facility 300b via a cable 301b when the charging device 1i is connected to the charging facility 300b at the charging station in the region B. Then, the charging device 1i stores the interconnection information as the interconnection information 632. When the interconnection information 632 includes a communication address for acquiring parameters, the controller 6i may access the server 600b through the communication unit 8i and the communication line 500b to acquire the parameters from the server 600b. As a result, the controller 6i can control the discharging operation of the bidirectional charger 5 to the terminal 4 side using the parameters corresponding to the region B.

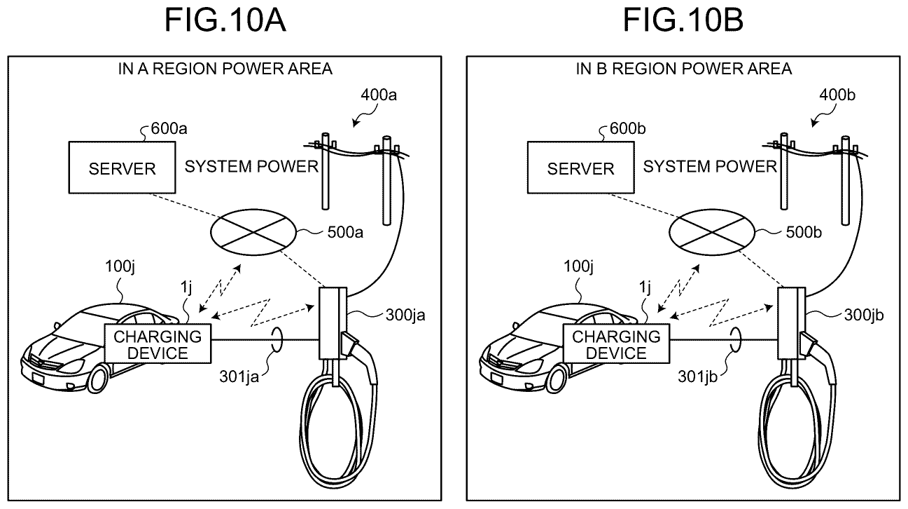

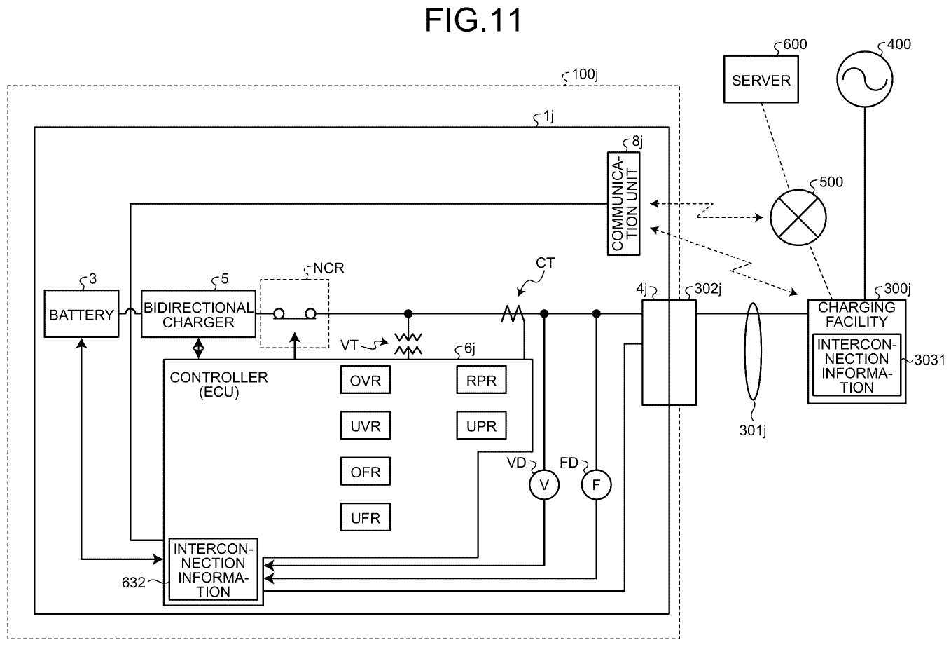

Moreover, as a second modification of the embodiment, a charging device 1j of a vehicle 100j may be capable of performing wireless communication as illustrated in FIGS. 10A and 10B, and FIG. 11. FIGS. 10A and 10B are diagrams illustrating charging and discharging at a destination of the vehicle 100j in which the charging device 1j according to the second modification of the embodiment is mounted. FIG. 11 is a diagram illustrating a configuration of the charging device 1j according to the second modification of the embodiment.

As illustrated in FIG. 11, the charging device 1j includes a communication unit 8j, and the communication unit 2 (FIGS. 2 and 9) is omitted. The communication unit 8j serves to communicate with the server 600 via a wireless communication link and the communication line 500. The communication unit 8j is connected to a controller 6j.

As illustrated in FIG. 10A, when the destination of the vehicle 100j is the region A, the charging device 1j receives interconnection information from the charging facility 300ja via the wireless communication link when the charging device 1j is connected to the charging facility 300ja at the charging station in the region A. The charging device 1j then stores the interconnection information as the interconnection information 632. When the interconnection information 632 includes a communication address for acquiring parameters, the controller 6j may access the server 600a through the communication unit 8j and the communication line 500a to acquire the parameters from the server 600a. As a result, the controller 6j can control the discharging operation of the bidirectional charger 5 to the terminal 4 side by using the parameters corresponding to the region A.

Alternatively, as illustrated in FIG. 10B, in a case where the destination of the vehicle 100jb is the region B, the charging device 1j receives interconnection information from the charging facility 300jb via the wireless communication link when the charging device 1j is connected to the charging facility 300b at the charging station in the region B. The charging device 1j then stores the interconnection information as the interconnection information 632. When the interconnection information 632 includes a communication address for acquiring parameters, the controller 6j may access the server 600b through the communication unit 8j and the communication line 500b to acquire the parameters from the server 600b. As a result, the controller 6j can control the discharging operation of the bidirectional charger 5 to the terminal 4 side by using the parameters corresponding to the region B.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging device comprising:
a communication circuit configured to receive interconnection information related to a technical requirement for interconnection with a system, the interconnection information being received from a charging facility connected to the system;
a battery configured to accumulate power;
a terminal configured to allow the charging device to be connected to the charging facility;
a bidirectional charger connected between the terminal and the battery, the bidirectional charger being configured to perform bidirectional conversion between AC power and DC power; and
a control circuit configured to
acquire one or more parameters in accordance with the interconnection information received by the communication circuit, and
control, by using the acquired parameters, a discharging operation to the terminal performed by the bidirectional charger.

2. The charging device according to claim 1, wherein the communication circuit is configured to
transmit an interconnection information request to the charging facility in response to connection of the charging facility to the terminal, and
receive interconnection information from the charging facility as a response to the interconnection information request.

3. The charging device according to claim 1, further comprising a first relay inserted into a line connecting the terminal to the bidirectional charger, the first relay being set to be in an ON state, wherein
the control circuit includes a second relay whose one end is disposed on a side of the line, the second relay being configured to detect a physical quantity related to voltage of the line, and
the control circuit is configured to
acquire a first parameter related to voltage and a second parameter related to time in accordance with the received interconnection information, and
stop the discharging operation of the bidirectional charger by shifting the first relay to an OFF state in accordance with a result detected by using the first parameter and the second parameter by the second relay.

4. The charging device according to claim 1, further comprising a first relay inserted into a line connecting the terminal to the bidirectional charger, the first relay being set to be in an ON state, wherein
the control circuit includes a second relay whose one end is disposed on a side of the line, the second relay being configured to detect a physical quantity related to frequency of the line, and
the control circuit is configured to
acquire a third parameter related to frequency and a fourth parameter related to time in accordance with the received interconnection information, and
stop the discharging operation of the bidirectional charger by shifting the first relay to an OFF state in accordance with a result detected by using the third parameter and the fourth parameter by the second relay.

5. The charging device according to claim 1, further comprising a first relay inserted into a line connecting the terminal to the bidirectional charger, the first relay being set to be in an ON state, wherein
the control circuit includes a second relay whose one end is disposed on a side of the line, the second relay being configured to detect a physical quantity related to power of the line, and
the control circuit is configured to
acquire a fifth parameter related to power and a sixth parameter related to time in accordance with the received interconnection information, and
stop the discharging operation of the bidirectional charger by shifting the first relay to an OFF state in accordance with a result detected by using the fifth parameter and the sixth parameter by the second relay.

6. The charging device according to claim 1, further comprising:
a first relay inserted into a line connecting the terminal to the bidirectional charger, the first relay being set to be in an ON state; and
a voltage detector whose one end is connected to the line, the voltage detector being configured to detect amplitude of voltage of the line,
wherein the control circuit is configured to
acquire a seventh parameter related to voltage and an eighth parameter related to time in accordance with the received interconnection information, and
control the discharging operation of the bidirectional charger to be continued by keeping the ON state of the first relay in accordance with the amplitude of the voltage detected by the voltage detector, the seventh parameter, and the eighth parameter.

7. The charging device according to claim 1, further comprising:
a first relay inserted into a line connecting the terminal to the bidirectional charger, the first relay being set to be in an ON state; and
a frequency detector whose one end is connected to the line, the frequency detector being configured to detect frequency of voltage of the line,
wherein the control circuit is configured to
acquire a ninth parameter related to frequency and a tenth parameter related to time in accordance with the received interconnection information, and
control the discharging operation of the bidirectional charger to be continued by keeping the ON state of the first relay in accordance with the frequency of the voltage detected by the frequency detector, the ninth parameter, and the tenth parameter.

8. A method of controlling a charging device, the charging device including a terminal allowing the charging device to be connected to a charging facility connected to a system, a battery to accumulate power, and a bidirectional charger connected between the terminal and the battery, the bidirectional charger serving to perform bidirectional conversion between AC power and DC power, the method comprising:
transmitting an interconnection information request to a charging facility in response to connection of the charging facility to the terminal of the charging device;
receiving interconnection information from the charging facility as a response to the interconnection information request;
acquiring one or more parameters in accordance with the received interconnection information; and
controlling, by using the acquired parameters, a discharging operation to the terminal performed by the bidirectional charger.

9. The method according to claim 8, further comprising:
transmitting an interconnection information request to the charging facility in response to connection of the charging facility to the terminal; and
receiving interconnection information from the charging facility as a response to the interconnection information request.

10. The method according to claim 8, wherein
the charging device further includes
a first relay inserted into a line connecting the terminal to the bidirectional charger, the first relay being set to be in an ON state, and
a second relay whose one end is disposed on a side of the line, the second relay serving to detect a physical quantity related to voltage of the line, and
the method further comprises:
acquiring a first parameter related to voltage and a second parameter related to time in accordance with the received interconnection information; and
stopping the discharging operation of the bidirectional charger by shifting the first relay to an OFF state in accordance with a result detected by using the first parameter and the second parameter by the second relay.

11. The method according to claim 8, wherein
the charging device further includes
a first relay inserted into a line connecting the terminal to the bidirectional charger, the first relay being set to be in an ON state, and
a second relay whose one end is disposed on a side of the line, the second relay serving to detect a physical quantity related to frequency of the line, and
the method further comprises:
acquiring a third parameter related to frequency and a fourth parameter related to time in accordance with the received interconnection information; and
stopping the discharging operation of the bidirectional charger by shifting the first relay to an OFF state in accordance with a result detected by using the third parameter and the fourth parameter by the second relay.

12. The method according to claim 8, wherein
the charging device further includes
a first relay inserted into a line connecting the terminal to the bidirectional charger, the first relay being set to be in an ON state, and
a second relay whose one end is disposed on a side of the line, the second relay serving to detect a physical quantity related to power of the line, and
the method further comprises:
acquiring a fifth parameter related to power and a sixth parameter related to time in accordance with the received interconnection information; and
stopping the discharging operation of the bidirectional charger by shifting the first relay to an OFF state in accordance with a result detected by using the fifth parameter and the sixth parameter by the second relay.

13. The method according to claim 8, wherein
the charging device further includes
a first relay inserted into a line connecting the terminal to the bidirectional charger, the first relay being set to be in an ON state, and
a voltage detector whose one end is connected to the line, the voltage detector serving to detect amplitude of voltage of the line, and
the method further comprises:
acquiring a seventh parameter related to voltage and an eighth parameter related to time in accordance with the received interconnection information; and
controlling the discharging operation of the bidirectional charger to be continued by keeping the ON state of the first relay in accordance with the amplitude of the voltage detected by the voltage detector, the seventh parameter, and the eighth parameter.

14. The method according to claim 8, wherein
the charging device further includes
a first relay inserted into a line connecting the terminal to the bidirectional charger, the first relay being set to be in an ON state, and
a frequency detector whose one end is connected to the line, the frequency detector serving to detect frequency of voltage of the line, and
the method further comprises:
acquiring a ninth parameter related to frequency and a tenth parameter related to time in accordance with the received interconnection information; and
controlling the discharging operation of the bidirectional charger to be continued by keeping the ON state of the first relay in accordance with the frequency of the voltage detected by the frequency detector, the ninth parameter, and the tenth parameter.
